(19) United States
(12) Patent Application Publication
(10) Pub. No.: US 2010/0036767 A1
(43) Pub. Date: Feb. 11, 2010

(54) Reserving amount of payment from financial account balance

(76) Inventors: Narasimha N. Sharoff, Beaverton, OR (US); Haren Myneni, Tigard, OR (US); Malahal R. Naineni, Tigard, OR (US); Sukadev Bhattiprolu, Beaverton, OR (US); Chandra Seetharaman, Portland, OR (US)

Correspondence Address: Law Offices of Michael Dryja (Austin), 1230 E Baseline Rd #103-248, Mesa, AZ, 85204, US

(21) Appl. No.: 12/187,261

(22) Filed: Aug. 6, 2008

(51) Int. Cl. G06Q 20/00; G06Q 40/00

(52) U.S. Cl. 705/39; 705/35

(57) ABSTRACT

In response to a payor planning a specific payment for a given amount to a payee, the given amount is reserved from a balance of a financial account of the payor from which the specific payment is to be made. As such, the given amount reserved from the balance is only available for settling the specific payment and is otherwise unavailable. After the payor has planned the specific payment for the given amount to the payee, in response to the specific payment for the given amount actually being made to the payee, the given amount reserved from the balance of the financial account is used to settle the specific payment for the given amount being made to the payee.

### FIELD OF THE INVENTION

The present invention relates generally to making payments from a financial account having a balance, and more particularly to reserve the amounts of specific payments within the balance such that the given amounts are only available to settle the specific payments and are otherwise unavailable for settling payments.

### BACKGROUND OF THE INVENTION

Most people have checking accounts or other types of financial accounts held at financial institutions such as banks and credit unions. A payor can plan a specific payment for a given amount to be made to a payee by writing a check to the payee, or by scheduling a recurring or a non-recurring electronic payment. The specific payment is actually made to the payee when the payee cashes the check, or when the electronic payment is processed on the date selected by the payor in question.

A problem can occur when by the time the specific payment is actually made to the payee, the remaining balance of the financial account is less than the given amount of the specific payment. In such instances, a check is said to have been bounced due to insufficient funds, or an electronic payment cannot be processed due to insufficient funds. This situation is more likely to occur when the specific payment is actually made to the payee (e.g., when a check is cashed by the payee) a long time after the payor planned the specific payment in question (e.g., when the check was written by the payor).

### SUMMARY OF THE INVENTION

A method of one embodiment of the present invention, in response to a payor planning a specific payment for a given amount to a payee, reserves the given amount from the balance of a financial account of the payor from which the specific payment is to be made. As such, the given amount reserved from the balance is only available for settling the specific payment and is otherwise unavailable. After the payor has planned the specific payment for the given amount to the payee, in response to the specific payment for the given amount actually being made to the payee, the method uses the given amount reserved from the balance of the financial account to settle the specific payment for the given amount being made to the payee.

An article of manufacture of one embodiment of the present invention includes a tangible computer-readable medium and means in the medium. The medium may be a recordable data storage medium, for instance. The means may be one or more computer programs stored on the medium for execution by one or more processors. The means is for performing a method. The method, in response to a payor planning a first payment for a first amount to a first payee, and in response to the payor deciding to reserve the first amount for settling the first payment to the first payee, subtracts the first amount from an unreserved balance of a balance of a financial account of the payor from which the first payment is to be made. The method also adds the first amount to a reserved sub-balance of the balance of the financial account. The first amount is reserved from the balance such that it is only available for settling the first payment and is otherwise unavailable. The unreserved sub-balance encompasses funds of the payor that have not been reserved for any specific payment, whereas the reserved sub-balance encompasses funds of the payor that have been reserved for one or more specific payments, including the first payment.

A system of one embodiment of the present invention includes hardware and a component implemented within the hardware. The component is to maintain a balance of a financial account of a user. The balance includes an unreserved sub-balance and a reserved sub-balance. The unreserved sub-balance encompasses funds of the payor that have not been reserved for any specific payment, whereas the reserved sub-balance encompasses funds of the payor that have been reserved for one or more specific payments. The component is to permit a payor to decide, for a specific payment being planned for a given amount to a payee, whether the given amount is to be reserved for settling the specific amount. Where the given amount is reserved by the payor, the component is to subtract the given amount from the unreserved sub-balance and add it to the reserved sub-balance. The given amount is reserved from the balance such that it is only available for settling the specific payment and is otherwise unavailable

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1A is a diagram depicting exemplarily representative performance of the prior art, whereas FIG. 1B is a diagram depicting exemplarily representative performance of an embodiment of the present invention by comparison.

FIGS. 2A and 2B are flowcharts of methods, according to varying embodiments of the present invention.

FIG. 3 is a diagram of a rudimentary representative computing system, according to an embodiment of the present invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

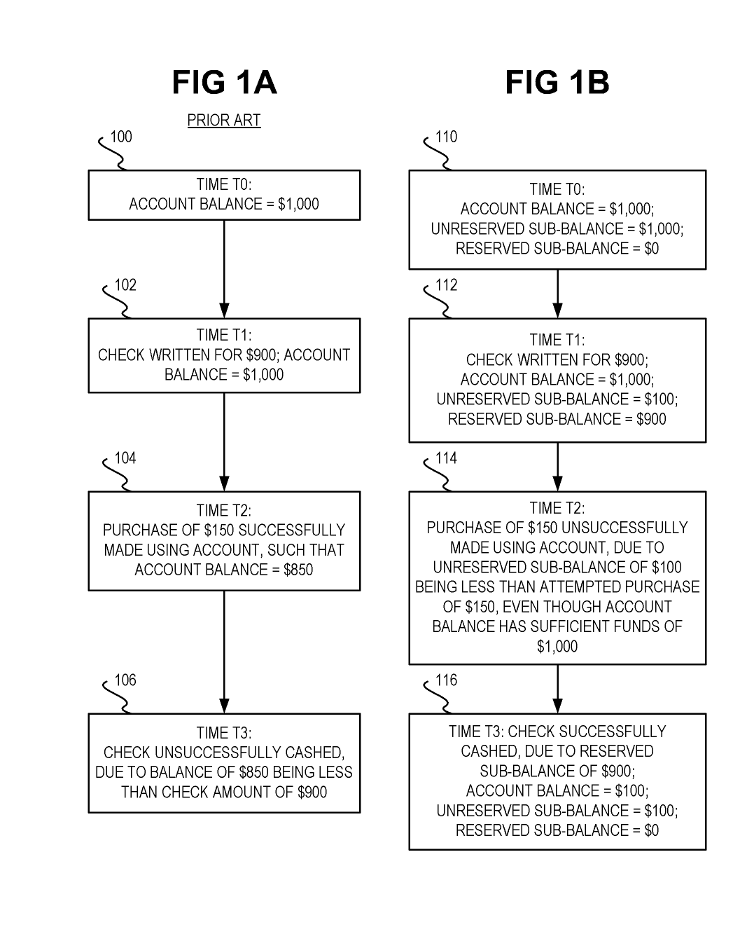

FIGS. 1A and 1B show exemplarily representative performance of the prior art and of an embodiment of the present invention, respectively. In both FIGS. 1A and 1B, time t0 occurs before time t1, which occurs before time t2, which occurs before time t3. In FIG. 1A, in accordance with the prior art, a payor has a checking account balance of $1,000 at time t0 (100). Thereafter, the payor writes a check for $900 to a payee against his or her checking account at time t1 (102). The account balance remains at $1,000, however, because while the check has been written, it has not yet been cashed.

Before the check is cashed, the payor successfully makes a purchase of $150 using a debit card linked to the checking account at time t2 (104). This purchase decreases the account balance to $850. Thereafter, when the payee attempts to cash the check for $900, he or she is unsuccessful at time t3 (106). This is because the account balance of $850 is less than the check amount of $900. Thus, even though the check was written at time t1 when the payor had available funds in the checking account, by the time the check was cashed at time t3 there were insufficient funds for the payee to cash the check.

By comparison, in FIG. 1B, in accordance with an embodiment of the invention, a payor again has a checking account balance of $1,000 at time t0 (110). The checking account balance is divided into two sub-balances: a reserved sub-balance, and an unreserved sub-balance. The reserve sub-balance encompasses funds within the account balance that have been specifically reserved for one or more particular payments, whereas the unreserved sub-balance encompasses funds within the account balance that have not been specifically reserved for any particular payment. At time t0, the unreserved sub-balance is $1,000, while the reserved sub-balance is $0. It is noted that the unreserved sub-balance plus the reserved sub-balance equals the account balance.

At time t1, the payor again writes a check for $900 to a payee against his or her checking account (112). The amount of $900 is also reserved specifically for payment of the check. Therefore, while the account balance remains unchanged at $1,000—because the check has only been written and has not yet been cashed—the reserved sub-balance is increased to $900 to cover the amount of the check, and the unreserved sub-balance is correspondingly decreased by $900 to $100.

Before the check is cashed, the payor attempts to make a purchase of $150 using a debit card linked to the checking account at time t2 (114). However, the payor is unsuccessful in making this purchase, because the unreserved sub-balance of $100 is less than the attempted purchase amount of $150. The purchase is unsuccessful even though the account balance itself has sufficient funds of $1,000 to cover the purchase of $150. However, $900 of the account balance has been reserved within the reserved sub-balance for payment of the check, and therefore is unavailable except for the check in question.

Thereafter, when the payee attempts to cash the check for $900, he or she is thus successful at time t3 (106). The $900 amount of the check is taken from the reserved sub-balance, such that the reserved sub-balance is decreased by $900 to $0. Because the account balance is equal to the reserved sub-balance plus the unreserved sub-balance, the account balance is also decreased by $900, to $100, which is the amount remaining within the unreserved sub-balance of $100.

This description of an embodiment of the invention in relation to FIG. 1B as compared to the prior art in relation to FIG. 1A shows how the present invention ensures that the temporal order in which payments are planned (e.g., checks being written, etc.) against a financial account can be preserved, regardless of when the payments are actually made. For example, at time t1 a check is written for $900 in part 112. At this time t1 the $900 amount of the check is reserved; as such, a subsequent purchase that is attempted to be made in $150 at time t2 fails in part 114 because there are insufficient unreserved funds. Therefore, when the check is in fact cashed at time t3 in part 116, there are still funds within the account to settle the check. This situation is desirable, because the check was written at time t1 in part 112 before the purchase was attempted to be made at time t2 in part 114. In other words, the temporal order in which the check was written and the purchase was attempted to be made is preserved—because the check is written before the purchase is attempted to be made, it is ensured (by reserving funds for the check) that the check will be able to be cashed even if it is cashed after the purchase is attempted to be made.

By comparison, the prior art does not ensure the temporal order in which payments are planned (e.g., checks being written, etc.) against a financial account are not preserved. For example, at time t1 a check is written for $900 in part 102; however, no funds are reserved for payment of the check. Therefore, when a purchase of $150 is made at time t2 in part 104 before the check has been cashed and which results in the account balance dropping below the amount of the check, subsequent cashing of the check at time t3 in part 106 is unsuccessful. This situation is undesirable, because the check was actually written at time t1 in part 102 before the purchase was made at time t2 in part 104, and therefore the payor may have desired that the check have priority over the purchase insofar as funds availability within the checking account is concerned. In other words, the temporal order in which the check was written and the purchase was made is not preserved—even though the check is written before the purchase is made, the funds for the purchase were allowed to be removed even though this resulted in sufficient funds for subsequent payment of the check.

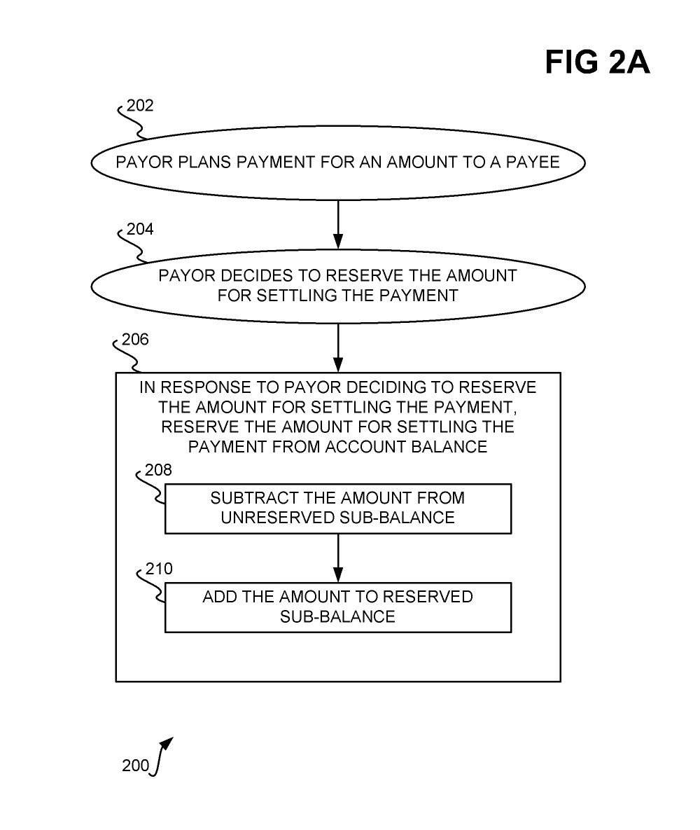

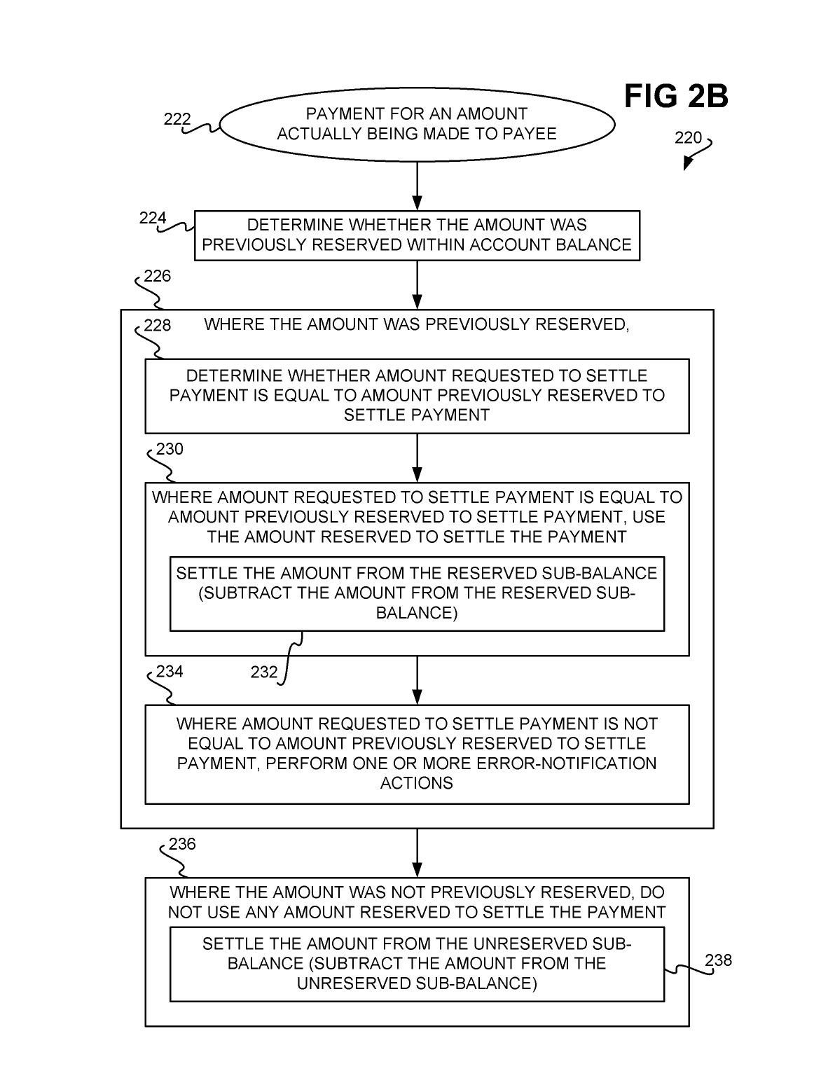

FIGS. 2A and 2B show methods 200 and 220, respectively, according to varying embodiments of the invention. In FIG. 2A, a payor plans a specific payment for a given amount to a payee (202). The payor may be an individual person, for instance. Payment planning may be achieved by the payor writing a check to the payee for the given amount Payment planning may alternatively be achieved by the payor setting up an electronic payment for the given amount of the payee. The electronic payment may be one of a series of periodically recurring automatic payments for the given amount.

The payor then decides to reserve the given amount for settling the specific payment, from a balance of a financial account from which the specific payment is to be made (204). The financial account may be a checking account or another type of financial account. The payor may hold the checking account with a financial institution, like a bank or another type of financial institution.

In response, the given amount is reserved from the balance of the financial account of the payor specifically for paying the specific payment (206). As such, the given amount reserved from the balance is only available for settling the specific payment, and is otherwise unavailable. For example, the given amount reserved is unavailable for settling other payments.

In one embodiment, the given amount is reserved from the balance of the financial account of the payor as follows. The given amount is subtracted from an unreserved sub-balance of the balance (208), and is added to a reserved sub-balance of the balance (210). As has been described, the unreserved sub-balance encompasses funds of the payor that have not been reserved for any specific payment, while the reserved sub-balance encompasses funds of the payor that have been reserved for one or more specific payments. The unreserved sub-balance plus the reserved balance is equal to the balance of the financial account of the payor. It is noted that in one embodiment no funds are actually moved within the financial account in question to reserve the given amount from the balance of the financial account.

The payor is able to reserve the given amount in a number of different ways. For instance, in one embodiment, the payor reserves the given amount by interacting with the financial institution online, such as via an online banking web site provided by the financial institution. In another embodiment, the payor reserves the given amount by calling the financial institution. The payor may speak with a customer service representative of the financial institution to reserve the given amount, or the payor may interact with an automated telephone prompt system provided by the financial institution to reserve the given amount.

Furthermore, in one embodiment, the payor is able to view the details of all the reserved funds and their associated payments. For example, a table is displayed to the payor online, via an online banking web site provided by the financial situation. The table includes a number of entries. Each entry includes a short description of the payment in question, such as “check #XYZ” or “electronic payment to be issued to payee ABC on date MM/DD/YY,” as well as the given amount reserved for the payment in question. Each entry also includes the date when the payor reserved the funds for each specific payment (e.g., the given amount of each specific payment). In one embodiment, the payor is also able to cancel the reservation of funds for a specific payment, such that the funds are returned from the reserved balance back to the unreserved balance.

In FIG. 2B, specific payment for a given amount is actually made to a payee (222), as previously planned by a payor. In the case of a check, for example, specific payment is actually made to the payee in one embodiment by the payee cashing the check or depositing the check into the payee's own financial account. In the case of an electronic payment, specific payment is actually made to the payee in one embodiment when the electronic payment is process for the given amount to the payee at the prescribed date such that the payee receives the given amount, and/or such that the electronic payment is subtracted from the balance of the payor's financial account. For example, an electronic payment may be set up on February 1 such that on February 10 the electronic payment is to be made. On February 10, then, the electronic payment is processed to ultimately pay the given amount to the payee. The given amount may be electronically transmitted from the payor's financial institution to the payee's financial institution at this time, or the payor's financial institution may cut a physical paper check and send it to the payee at this time.

It is determined whether the given amount of the specific payment in question was previously reserved from the balance of the payor's financial account (224). For example, the check number or the electronic payment identifier may be referenced against a list of specific payments for which given amounts have been reserved. If the amount of the specific payment in question was indeed previously reserved, then the following is responsively performed in one embodiment (226).

It is determined whether the amount requested by the payee to settle the specific payment is equal to the given amount previously reserved by the payor to settle the specific payment (226). This can include determining the amount requested by the payee to settle the specific payment. For example, a payor may have written a check for $900 to a payee, such that the given amount of $900 was reserved for settling this check. Normally, the payee will present the check for cashing or depositing in the same amount of $900 to settle the payment, in which case the amount requested by the payee to settle the payment is equal to the given amount previously reserved by the payor. However, the payee may fraudulently change the amount on the check prior to cashing or depositing, such as to $1,900, to settle the payment. In this case, the amount requested by the payee to settle the payment is not equal to the given amount previously reserved by the payor.

Where the amount requested by the payee to settle the specific payment is equal to the given amount previously reserved by the payor to settle the specific payment, the amount reserved is used to settle the payment (230). In one embodiment, then, the given amount is settled from the reserved sub-balance to which the given amount was previously added (232). That is, the given amount is subtracted from the reserved sub-balance of the balance of the payor's financial account.

By comparison, where the amount requested by the payee to settle the specific payment is not equal to the given amount previously reserved by the payor to settle the specific payment, one or more error-notification actions are performed (234). In one embodiment, the payor is notified that the amount being requested by the payee to settle the specific payment differs from the given amount previously reserved from the balance of the payor's financial account. In one embodiment, the specific payment is prevented from being settled from the balance of the payor's financial account until this difference between the requested amount and the reserved amount is resolved.

Finally, in the case where the given amount of the specific payment was not previously reserved by the payor, no amount previously reserved is used to settle the specific payment (236). In one embodiment, therefore, the given amount is settled from the unreserved sub-balance of the balance of the payor's financial account (238), by, for instance, subtracting the given amount from the unreserved sub-balance. In other words, the given amount is not settled from the reserved sub-balance, and no reserved funds are used to settle the specific payment.

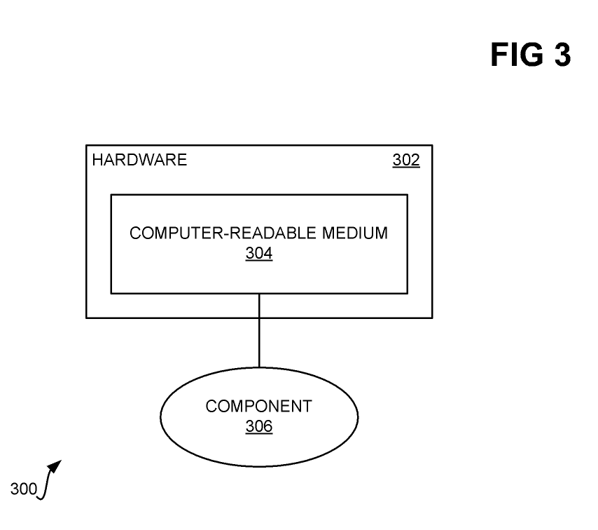

FIG. 3 shows a representative rudimentary computing system 300, according to an embodiment of the invention. The computing system 300 includes hardware 302, such as a tangible computer-readable medium 304 like a recordable data storage medium. Examples of recordable data storage media include hard disk drives and semiconductor memories, for instance. A component 306 is implemented via the hardware 302. For instance, in one embodiment the component 306 includes one or more computer programs that are stored on the tangible computer-readable medium 304, where these programs are executed by one or more processors. The component 306 can be considered the means that implements the functionality performed by the component 306.

The component 306 maintains the balance of the payor's financial account, including the unreserved sub-balance and the reserved sub-balance. The component 306 permits the payor to decide, for a specific payment being planned for a given amount to a payee, whether the given amount is to be reserved for settling the specific payment. The component 306 then reserves the given amount where the payor decides to reserve this amount. More generally, the component 306 particularly performs at least some of the parts of the methods 200 and 220 of FIGS. 2A and 2B.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. Therefore, it is manifestly intended that this invention be limited only by the claims and equivalents thereof.

1. A method comprising:
in response to a payor planning a specific payment for a given amount to a payee,
reserving, by using a processor of a hardware computer system, as directed by the payor, the given amount from a balance of a financial account of the payor from which the specific payment is to be made, at a time at which the payor planned the specific payment for the given amount to the payee, such that the given amount reserved from the balance is only available for settling the specific payment and is otherwise unavailable; and,
after the payor has planned the specific payment for the given amount to the payee, in response to the specific payment for the given amount actually being made to the payee,
using, by the processor of the hardware computing system, the given amount reserved from the balance of the financial account to settle the specific payment for the given amount being made to the payee.

2. The method of claim 1, wherein the payor planning the specific payment for the given amount to the payee comprises the payor writing a check to the payee for the given amount, and
wherein the specific payment for the given amount being made to the payee comprises the payee cashing or depositing the check.

3. The method of claim 1, wherein the payor planning the specific payment for the given amount to the payee comprises the payor setting up an electronic payment for the given amount to the payee, and
wherein the specific payment for the given amount being made to the payee comprises processing the electronic payment for the given amount to the payee such that the payee receives the given amount.

4. The method of claim 3, wherein the electronic payment is one of a series of periodically recurring payments for the given amount to the payee.

5. The method of claim 1, wherein reserving the given amount from the balance of the financial account of the payor from which the specific payment is to be made is performed in response to the payor deciding to reserve the given amount.

6. The method of claim 1, wherein reserving the given amount from the balance of the financial account of the payor from which the specific payment is to be made comprises:
subtracting the given amount from an unreserved sub-balance of the balance of the financial account;
adding the given amount to a reserved sub-balance of the balance of the financial account,
wherein the unreserved sub-balance of the balance of the financial account encompasses funds of the payor that have not been reserved for any specific payment, and
wherein the reserved sub-balance of the balance of the financial account encompasses funds of the payor that have been reserved for one or more specific payments.

7. The method of claim 6, wherein using the given amount reserved from the balance of the financial account to settle the specific payment for the given amount being made to the payee comprises subtracting the given amount from the reserved sub-balance of the balance of the financial account.

8. The method of claim 6, further comprising, in response to an unreserved payment being made from the financial account, settling the unreserved payment from the unreserved balance of the balance of the financial account.

9. The method of claim 1, further comprising, in response to the specific payment for the given amount being made to the payee,
determining an amount being requested by the payee to settle the specific payment;
where the amount being requested by the payee to settle the specific payment is unequal to the given amount reserved from the balance of the financial account,
performing one or more error-notification actions.

10. The method of claim 9, wherein the one or more error-notification actions comprise one or more of:
notifying the payor that the amount being requested by the payee to settle the specific payment differs from the given amount reserved from the balance of the financial account;
preventing the specific payment being settled from the balance of the financial account until a difference between the amount being requested by the payee to settle the specific payment and the given amount reserved from the balance of the financial account is resolved.

11. The method of claim 1, wherein no funds are actually moved within the financial account in reserving the given amount from the balance of the financial account.

12. An article of manufacture having a computer-readable medium storing one or more computer programs, where execution of the computer programs by a processor causes a method to be performed, the method comprising:
in response to a payor planning a first payment for a first amount to a first payee,
in response to the payor deciding to reserve the first amount for settling the first payment to the first payee,
at a time at which the payor planned the first payment for the first amount to the first payee and decided to reserve the first amount for settling the first payment to the first payee,
subtracting the first amount from an unreserved sub-balance of a balance of a financial account of the payor from which the first payment is to be made;
adding the first amount to a reserved sub-balance of the balance of the financial account,
wherein the first amount is reserved from the balance such that the first amount is only available for settling the first payment and is otherwise unavailable,
wherein the unreserved sub-balance of the balance of the financial account encompasses funds of the payor that have not been reserved for any specific payment, and
wherein the reserved sub-balance of the balance of the financial account encompasses funds of the payor that have been reserved for one or more specific payments, including the first payment.

13. The article of manufacture of claim 12, wherein the method further comprises:
in response to a second payment for a second amount actually being made to a second payee,
after determining whether the second amount was previously reserved by the payor for settling the second payment to the second payee,
where the second amount was previously reserved by the payor,
using the second amount reserved within the reserved sub-balance of the balance of the financial account to settle the second payment, including subtracting the second amount from the reserved sub-balance of the balance of the financial account.

14. The article of manufacture of claim 13, wherein the method further comprises:
in response to the second payment for the second amount actually being made to the second payee,
after determining whether the second amount was previously reserved by the payor for settling the second payment to the second payee,
where the second amount was not previously reserved by the payor,
settling the second payment from the unreserved sub-balance of the balance of the financial account, including subtracting the second amount from the unreserved sub-balance of the balance of the financial account.

15. The article of manufacture of claim 13, wherein the method further comprises:
in response to the second payment for the second amount actually being made to the second payee,
after determining whether the second amount was previously reserved by the payor for settling the second payment to the second payee,
where the second amount was previously reserved by the payor,
determining an amount being requested by the second payee to settle the second payment;
where the amount being requested by the second payee to settle the second payment is unequal to the second amount reserved by the payor,
performing one or more error-notification actions.

16. A system comprising:
hardware, including a processor;
a tangible computer-readable medium;
a component implemented as one or more computer programs stored on the tangible computer-readable medium and executed by the processor of the hardware,
wherein the component is to maintain a balance of a financial account of a payor, the balance including an unreserved sub-balance and a reserved sub-balance, the unreserved balance encompassing funds of the payor within the financial account that have not been reserved for any specific payment, the reserved balance encompassing finds of the payor that have been reserved for one or more specific payments,
wherein the component is to permit a payor to decide for a specific payment being planned for a given amount to a payee whether the given amount is to be reserved for settling the specific payment, such that where the given amount is reserved by the payor, the component is to subtract, at a time at which the payor decided that the given amount is to be reserved for settling the specific payment, the given amount from the unreserved sub-balance and add the given amount to the reserved sub-balance, and
wherein the given amount is reserved from the balance such that the given amount is only available for settling the specific payment and is otherwise unavailable.

17.-19. (canceled)
